(19) United States
(12) Patent Application Publication
(10) Pub. No.: US 2008/0029456 A1
(43) Pub. Date: Feb. 7, 2008

(54) Method and apparatus for removing minerals from a water source

(75) Inventors: Leonard L. Dueker, Mesa, AZ (US); C. Brent Cluff, Thatcher, AZ (US)

Correspondence Address: LaValle D. Ptak, Ste. B, 28435 N. 42nd St., Cave Creek, AZ, 85331, US

(73) Assignee: Southwest Turf Solutions, Inc.

(21) Appl. No.: 11/499,160

(22) Filed: Aug. 3, 2006

(51) Int. Cl. B01D 61/00

(52) U.S. Cl. 210/641; 210/652; 210/650; 210/806; 210/259; 210/321.72

(57) ABSTRACT

A system and method for removing minerals from a water source and concentrating these minerals for ease of reuse or disposal includes passing the water from a suitable source through cascaded membrane filters, the reject outputs of each of which are connected to the inputs of the next membrane filter in the cascade. At the input of each of the membrane filters, a pre-filter in the form of a micro-filtration filter, an ultra filtration filter, or a slow sand filter, is used to remove sediment and impurities from the water stream prior to the application of the water to the input of the next membrane filter in the cascade.

### BACKGROUND

Many municipal water sources include high concentrations of dissolved minerals, at least some of which must be removed prior to supplying the water to ultimate consumers. In addition, particularly in areas of limited water supply, sewage effluent is processed for use in watering golf courses, parks and the like. Such effluent generally includes a high concentration of minerals.

There are several methods of concentrating reject water from water processing systems for disposal of that reject water. These methods include evaporation ponds, high efficiency reverse osmosis, thermal brine concentration, brine crystallization, and others. Removal and concentration of minerals in systems currently in use, however, are economical only if large quantities of water are processed. Presently, there is no practical and economical process for water flows of three million (3,000,000) gallons per day and smaller.

Evaporation ponds frequently are used to concentrate the brine or mineral concentrate. Depending upon the climate and temperature (that is, sunshine, rain or snow), the evaporation rate will vary. Different rates of evaporation require varying pond areas since the losses due to evaporation also vary by the surface area of the water exposed to the atmosphere. Evaporation pond processes require large areas of land. This can become expensive if the cost of land is high, unless the reject brine from the process can be concentrated into a very small quantity of liquid.

High efficiency reverse osmosis processes consist of lime softening, hardness polishing through weak acid cation exchange, pH increase, and reverse osmosis with sea water RO membranes. These processes are used in conjunction with obtaining drinking water from sea water, and are relatively expensive systems, particularly for smaller systems when processing several million gallons of water per day.

Another technique which has been used is thermal brine concentration. This type of a system recovers some of the waste stream through evaporation and vapor compression in large facilities. Thermal brine concentration systems require the addition of energy in the form of heat, and also require high pressure pumps. This process, because of the size of the equipment required, does not lend itself to small applications (that is, applications of less than 3,000,000 gallons per day).

Another technique for removing and concentrating the reject water from a water processing system is a thermal flash evaporation process, which causes the formation of salt crystals in a brine solution. Thermal flash evaporation requires energy to keep the process under pressure circulation, and requires the addition of heat. This process requires relatively massive large scale equipment, and does not lend itself to small applications of under 3,000,000 gallons per day.

Electrodialysis reversal (EDR) technology has been used for many years. This technology, however, has had limited testing and application in treating wastewater tertiary effluent for re-use. Even with an EDR system, fouling can be a particular concern when treating tertiary effluent from a municipal wastewater treatment plant.

Water treatment using reverse osmosis (RO) technology leaves a reject stream with a concentration of suspended solids, plus added antiscalant, anti-flocculent chemicals, dissolved organics, minerals and other pollutants which are removed from the product water produced by the RO technology. The disposition of this reject stream is difficult in many situations. For some cases, the reject stream pollutants pose a liability for the users of the product water. In addition, the loss of the ten percent to fifty percent reject for any beneficial use also poses a problem in water short areas, where all water resources are needed.

The treatment of water with a slow sand and natural filtration system shown in the U.S. Pat. No. 5,112,483 to Cluff for scaling control provides good quality water for many purposes at a reasonable cost. The system disclosed in the Cluff patent uses a slow sand filter to receive the water being treated. The output of the slow sand filter then is supplied through a cascade of nano filtration filters, which may include a catalytic conditioner or magnetic water conditioner in the system. Although the system of the Cluff patent exhibits improved efficiency, a relatively high percentage of reject and the attendant disposal problems for the reject still are present in the system. The Cluff system, however, does provide combined benefits of nano filtration units and a slow sand filter. As is well known, slow sand filters not only serve to physically filter the sediment and other impurities from the water supplied to the filter, but also provide a conducive environment for micro-organisms which further purify the water, removing some-organic matter. The micro organisms modify the electrical charge so that clay is easily removed by the slow sand filter. The biological treatment produced by slow sand filters is not available in rapid sand gravity or pressurized filters. Unlike with slow sand filters, clay removal is not accomplished without the use of flocculents. Unused flocculents foul RD membranes.

Nano-filtration filter membranes have a higher molecular cutoff than the membranes of reverse osmosis (RO) systems. The membrane of a nano-filtration filter is “coarser” than that of a reverse osmosis filter; and because of this fact, it will pass most of the sodium chloride and reject bivalent ions, calcium, magnesium and sulfate. Previously, nano filter membranes would produce more permeate than the RO; but recent advances have improved the RO membrane to the point that there is not as much difference in production.

It is desirable to provide an improved system and method for removing minerals from a source of water, which overcomes the disadvantages of the prior art.

### BRIEF DESCRIPTION OF THE DRAWINGS

FIG. 1 is a block diagram of a system in accordance with an embodiment of the invention; and

FIGS. 2 through 5 are graphs useful in describing the results of the-operation of the system shown in FIG. 1.

### DETAILED DESCRIPTION

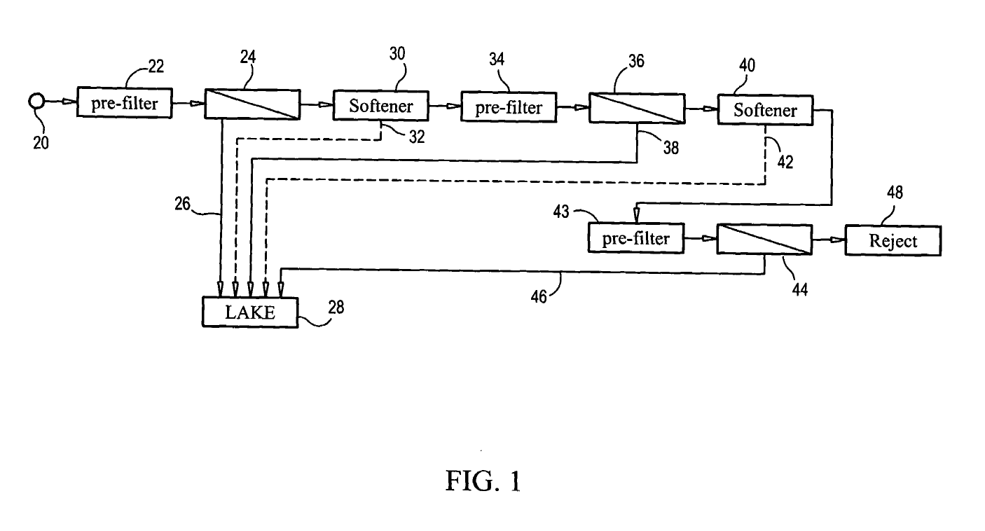

Reference now should be made to FIG. 1, which is a block diagram of a system in accordance with an embodiment of the invention. As shown in FIG. 1, a source of water 20 is used to supply the feed water to be processed by the system. The water source 20 may be surface water, ground water, brackish water, or effluent reclaimed from wastewater. The system of FIG. 1 may be used in conjunction with processing effluent from wastewater to provide irrigation water for golf courses, parks and the like.

Some of the water 20 may contain chlorine, which destroys organisms working in slow sand filters. If chlorine is present, it must be removed; and a common method is to inject sodium thiosulphate into the feed-water 20. The manner in which this is done, if it is necessary, is conventional and therefore has not been illustrated in FIG. 1.

As shown in conjunction with the embodiment of FIG. 1, the processing system for removing minerals from the water source 20 and concentrating these minerals for ease of disposal constitutes a cascade of several elements. The source of water initially is supplied through a first pre-filter 22, which typically may be a micro-filtration filter, an ultra filtration filter, a biological filter, or a slow sand filter, all of which are used to enhance and reduce the fouling of subsequent stages of membrane-type filters, such as nano-filtration filters or reverse osmosis (RO) filters.

For the system shown in FIG. 1, slow sand filters (SSF) have been found convenient because of their relatively low cost and because of the biological benefits provided, as generally described above. If a slow sand filter is used for the pre-filter 22 (and also for the pre-filters 34 and 43), approximately seven square feet of filter area per 1,000 gallons per day (gpd) of flow is required. In addition, either as part of or in conjunction with the pre-filter 22 (and pre-filters 34 and 43) a 5 micron filter, either external to the various membrane filters disclosed, or located in the input side of the membrane filters, may be provided. The 5 micron filtration may be inherent in the characteristics of the pre-filters 22,34, and 43; but it can be added as an extra element if necessary.

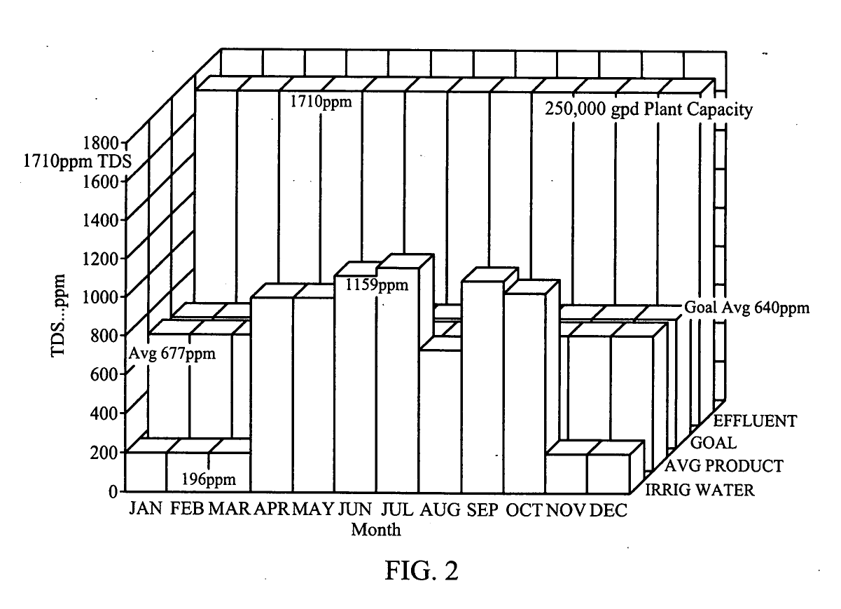

The output water flow from the first pre-filter 22 is supplied to the input of a first membrane filter 24. The filter 24 and second and third membrane filters 36 and 44 may be either nano-filtration filters or reverse osmosis (RO) filters, depending upon the particular application which is to be made of the system. In the system described in conjunction with the graphs of FIGS. 2 through 5, the filters 24,34 and 44 are RO filters.

As noted, feed to the first RO filter 24 is from the slow sand filter or pre-filter 22, into which effluent from a municipal wastewater plant or other water which has mineral levels higher than desired is first treated with sodium thiosulphate to remove chlorine. The permeate or product from the RO filter 24 is supplied over a line 26 to a lake 28 or other suitable storage facility.

The reject output from the RO membrane filter 24 is supplied to a softener 30, which typically uses a lime treatment, or lime plus soda ash treatment to precipitate calcium (Ca) and magnesium (Mg) out of the reject stream from the water flow, prior to supplying the reject stream to the input of the second pre-filter 34. The precipitation of calcium and magnesium is in the form of calcium hydroxide and magnesium hydroxide, which may be separately removed, or, as shown in FIG. 1, supplied from the softener 30 over a line 32 into the lake or storage facility. The lines 26,32,38 and 42 may be combined into a single pipeline.

The amount of lime which is used in the softener 30 may be empirically determined from the nature of the reject supplied from the filter 24 as a result of the condition of the water supplied at 20 to the first pre-filter 22. By precipitating the calcium and magnesium from the water, the hardness is substantially reduced prior to supplying the softened water from the softener 30 to the second pre-filter 34, as shown in FIG. 1. The use of slow sand filters for these pre-filters carries the additional capability of purification of the water through microorganisms present in the slow sand bed.

The output of the second pre-filter 34 is supplied to the input of second membrane filter or RO filter 36, which is similar to the filter 24, described previously. The permeate from the filter 36 is supplied over a line 38 to the lake or storage facility 28. The reject from the filter 36 is supplied to a second softener 40 which operates in the same manner as the softener 30 to precipitate additional calcium and magnesium from the reject water stream. This precipitated calcium and magnesium may be separately disposed of, or supplied over the line 42 to the lake 28, as described previously in conjunction with the softener 30. The output of the softener 40 then is supplied to a third pre-filter 43, which then supplies its output to the input of a third membrane filter 44, which may be a nano-filtration filter or an RO filter. Typically, the unit 44 is what is known as a “sea water” RO unit capable of handling the significantly higher levels of minerals entering the unit after the reject water has been concentrated by the previous two membrane filters 24 and 36.

The filters 24 and 36, if RO filters are employed, operate at approximately 175 pounds per square inch (psi) input pressure, while the filter 44 operates at approximately 1,000 psi. The output from the permeate output of the filter 44 is supplied to the lake or storage facility 28; and the final reject (brine) is discharged at 48 to an evaporation pond, or other processes or equipment to further concentrate the final reject, such as a tank, or other suitable containers for removal.

Before passing the softened water from the softeners 30 and 40 back to the pre-filters 34 and 43, it is desirable to adjust the pH back down from the relatively high level resulting from the lime treatment to a lower level. This increases the capacity of the water to carry calcium and magnesium without scaling. It also prevents the microbes in a slow sand filter (if a slow sand filter is used for the filters 34 and 43) from being destroyed by a high pH.

In a system which has been operated as shown in FIG. 1, a waste water pilot project was operated with an input at 20 gpm. If the results (data) at the 2 gpm pilot, using three cascading RO's, were used to project the operation of a two hundred fifty thousand (250,000) gallons per day (gpd) process using effluent 20, this would result in an input of 174 gallons per minute (gpm). The total dissolved solids (TDS) in the input water 20 would be approximately 1,260 parts per million (ppm). This input would be supplied at 20, through a first slow sand pre-filter 22, to an RO unit 24 operating at 175 psi. The permeate applied over the line 26 from the unit 24 would be 190,000 gpd, or 132 gpm, with a concentration of 60 ppm total TDS.

The reject feed from the RO unit 24 to the softener 30 would be 60,000 gpd, or 42 gpm, with a concentration of 5,061 ppm TDS. As noted above, lime added by the softener 30 would precipitate the calcium and magnesium from the reject; and these precipitated minerals would be added to the lake 28 which would be used as irrigation water for a golf course. The second RO unit 36 would operate at 175 psi, as noted above, and supply permeate product to the lake 28 over the output line 38 at 37,900 gpd or 27 gpm at a mineral concentration of 288 ppm.

The reject output of the RO filter 36 supplied to the softener 40 would be at the rate of 22,105 gpd or 15 gpm, with a concentration of 17,300 ppm TDS. Again, precipitation of the calcium and magnesium by the softener 40 would take place prior to application of this reject feed to the pre-filter 43, the output of which then would be supplied to the third sea water RO unit 44 operating at 1,000 psi. The permeate or useful output from the filter 44 applied over the line 46 to the lake 28 would be at the rate of 17,680 gpd or 12 gpm at a concentration of 740 ppm. The final reject 48 from the output of the RO unit 44, would be supplied to drying beds, other processes or equipment to further concentrate the final reject, such as tanks or other disposal means at a rate of 4,420 gpd or 3 gpm, with a concentration of 91,000 ppm TDS.

The summary of all of the products supplied to the lake 28 would amount to 245,580 gpd, or 171 gpm, with an average TDS of 134 ppm. This is a very acceptable level for use as irrigation water for golf courses, parks and similar facilities. This water may be used alone or combined with some of the water 20, or water from other sources, if desired.

Adding the lime used in the softeners 30 and 40 lowers the Sodium Adsorption Ratio (SAR). Reduction in soil permeability is a chronic problem for golf courses, parks and the like; and this reduction can happen at much lower concentrations of sodium. SAR is a measure of the relative concentrations of the sodium ion and the calcium and magnesium ions, and it is a way to evaluate the effect that the sodium concentration has on the soil permeability. By adding softening materials in the softeners 30 and 40 to the product water, to remove calcium and magnesium, the SAR is lowered, and therefore, constitutes another benefit to the golf course turf or the like.

Reference now should be made to FIGS. 2 through 5, which are graphs of a one-year operation of a 250,000 gpd plant capacity system to determine the efficiency of the system. RIGS. 2,3,4 and 5 are graphs, respectively, of TDS, sodium, chloride, and SAR for a combination of irrigation water and wastewater effluent input to the RO cascade of FIG. 1 having 1,710 ppm TDS in it. After processing as described above, the product from the lake 28 may be blended with varying amounts of water from other sources. The graphs cover twelve months, indicating the goal average of TDS, as well as the average product over the various months. As can be seen from FIG. 2, the spring and summer months included the highest concentrations of TDS in the irrigation water; but the average product (250,000 gpd from the system of FIG. 1 combined with varying amounts of water) would exceed the goal by only a slight amount (677 ppm compared with a goal of 640 ppm).

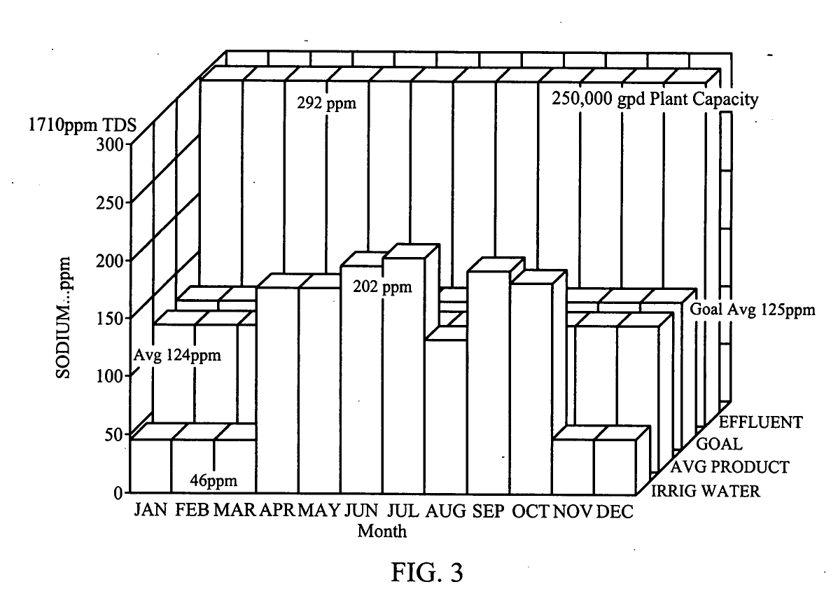

FIG. 3 shows the sodium concentration of the input water 20 at 292 ppm and an average goal for the year, desired at 125 ppm. The average of a combined processed effluent 20 and irrigation water 28 product over the twelve month period would be 124 ppm. Again, the months from April through October would constitute the highest concentrations of sodium in the combined irrigation water.

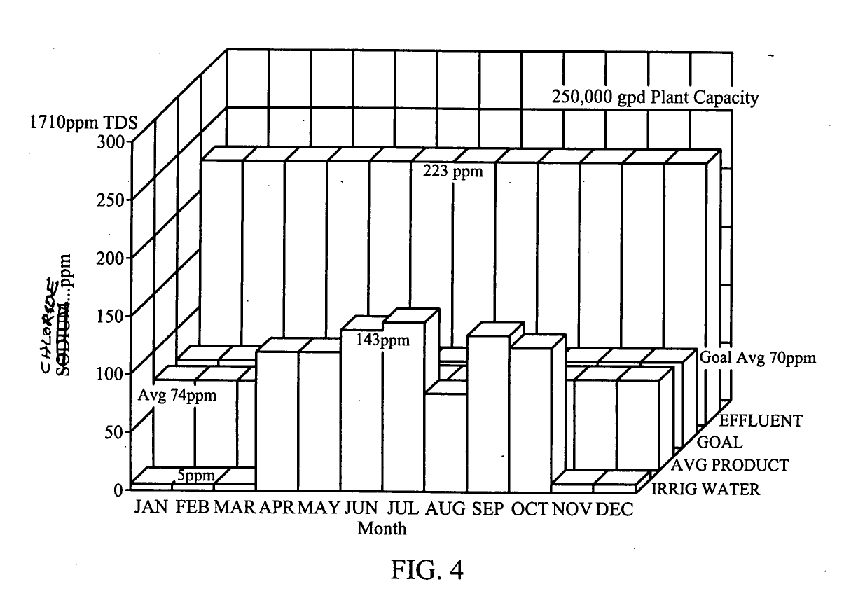

FIG. 4 shows the chloride concentration of the input water at 223 ppm; and a goal of 70 ppm. The average over the year would be 74 ppm of chloride. Again, the months of April through October would be the highest concentrations in the irrigation water when product water 28 would be combined with the processed effluent 20.

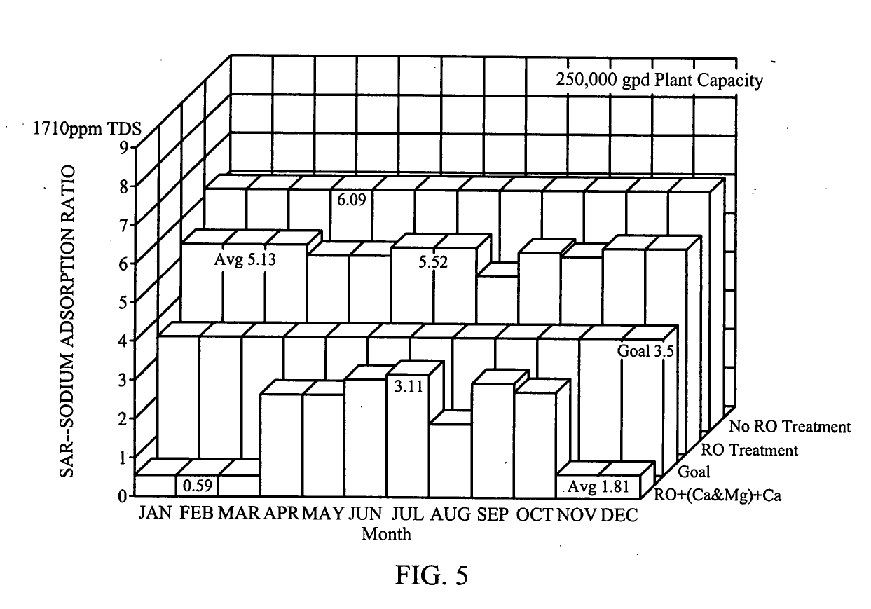

Finally, FIG. 5 shows the sodium adsorption ratio (SAR) with the effluent input water 20 having a ratio of 6.09. Compared to a goal of 3.5; and with no softeners, the RO treatment would produce an average of 5.13 over the course of a year. By the additions of the softeners 30 and 40 for precipitating out the calcium and magnesium, an average of 1.81 SAR would be achieved, with the lowest amounts occurring in the months of November through March. Again, as with the other charts, the months of April through October produced the highest amounts of SAR because of the use of larger amounts of effluent water 20. FIG. 5 clearly shows the advantage of the addition of the softener stages 30 and 40 to the system for improving the sodium adsorption ratio (SAR).

The lime softening process in repeated RO applications can be used to supply-domestic water. The difference would be that the product water would be stored in a covered tank instead of a lake. The magnesium and calcium sludge fro lime softening would be sent to drying beds before being harvested for sale to agriculture or industrial users.

The foregoing description of an embodiment of the invention is to be considered as illustrative and not as limiting. Modifications will occur to those skilled in the art for performing substantially the same function, in substantially the same way, to achieve substantially the same results without departing from the true scope of the invention as defined in the appended claims.

What is claimed is:

1. A method for removing minerals from a water source including: passing water from a source of water through a pre-filter to remove larger particles from the output thereof; supplying the output of the first pre-filter (use first earlier) to a first membrane filter to produce a permeate output and a reject output; supplying the permeate output of the first membrane filter to a point of use; supplying the reject output of the first membrane filter through a second pre-filter to a second membrane filter to produce a permeate output and a reject output; and supplying permeate output of the second membrane filter to the point of use.

2. The method according to claim 1 wherein the first and second pre-filters are slow sand filters.

3. A method according to claim 2 wherein the first and second membrane filters are reverse osmosis (RO) filters.

4. The method according to claim 3 wherein the first and second pre-filters filter out particles greater than 5 microns in size.

5. A method according to claim 4 further including removing calcium (Ca) and magnesium (Mg) from the reject output of the first membrane filter.

6. A method according to claim 5 wherein removing the calcium and magnesium from the reject output of the first membrane filter includes softening of the reject output of the first membrane filter.

7. A method according to claim 6 further including supplying the reject output of the second membrane filter through a third pre-filter to a third membrane filter to produce a permeate output and a reject output therefrom; and supplying the permeate output of the third membrane filter to the point of use.

8. A method according to claim 7 wherein the third membrane filter is a sea water reverse osmosis membrane filter.

9. A method according to claim 8 further including discharging the reject output of the third membrane filter as waste.

10. A method according to claim 9 further including removing calcium (Ca) and magnesium (Mg) from the reject output of the second membrane filter prior to supplying that output through the third pre-filter to the third membrane filter.

11. A method according to claim 1 further including supplying the reject output of the second membrane filter through a third pre-filter to a third membrane filter to produce a permeate output and a reject output therefrom; and supplying the permeate output of the third membrane filter to the point of use.

12. A method according to claim 11 wherein the third membrane filter is a sea water reverse osmosis membrane filter.

13. A method according to claim 12 further including discharging the reject output of the third membrane filter as waste.

14. A method according to claim 1 wherein the first and second membrane filters are reverse osmosis (RO) filters.

15. A method according to claim 14 further including supplying the reject output of the second membrane filter through a third pre-filter to a third membrane filter to produce a permeate output and a reject output therefrom; and supplying the permeate output of the third membrane filter to the point of use.

16. A method according to claim 15 wherein the third membrane filter is a sea water reverse osmosis membrane filter.

17. The method according to claim 1 wherein the first and second pre-filters filter out particles greater than 5 microns in size.

18. A method according to claim 1 further including removing calcium (Ca) and magnesium (Mg) from the reject output of the first membrane filter.

19. A method according to claim 18 wherein removing the calcium and magnesium from the reject output of the first membrane filter includes softening of the reject output of the first membrane filter by means of a lime treatment.

20. A system for removing minerals from a water source including: at least first and second membrane filters each having an input and each having a permeate output and a reject output; at least first and second pre-filters selected from the group of slow sand filter, ultra filtration filter, and micro-filtration filter, each of said at least first and second pre-filters having an input and an output; a fluid connection from the water source to the input of the first pre-filter; fluid connections between the output of the first pre-filter and the input of the first membrane filter between the reject output of the first membrane filter and the input of the second pre-filter, and between the output of the second pre-filter and the input of the second membrane filter; and connections of the permeate outputs of both of the first and second membrane filters to a point of use.

21. A system according to claim 20 further including a softener connected between the reject output of the first membrane filter and the input of the second membrane filter.

22. A system according to claim 21 wherein the first and second membrane filters are reverse osmosis filters.

23. A system according to claim 22 wherein the first and second pre-filters are selected from the group of slow sand filters, biological filters, micro-filtration filters, and ultra-filtration filters.

24. A system according to claim 23 further including a third pre-filter having an input and an output; and a third membrane filter having an input and a permeate output and a reject output, with the input of the third pre-filter connected to the reject output of the second membrane filter and the output of the third pre-filter connected to the input of the third membrane filter, with the permeate output of the third membrane filter connected to the point of use.

25. The system according to claim 24 wherein the third membrane filter is a sea water reverse osmosis unit.

26. A system according to claim 25 wherein the first and second pre-filters are selected from the group of slow sand filters, biological filters, micro-filtration filters, and ultra-filtration filters.

27. The system according to claim 25 further including a second softener connected between the reject output of the second membrane filter and the input of the third membrane filter.

28. A system according to claim 20 wherein the first and second membrane filters are reverse osmosis filters.

29. A system according to claim 20 wherein the first and second pre-filters are selected from the group of slow sand filters, biological filters, micro-filtration filters, and ultra-filtration filters.

30. A system according to claim 20 further including a third pre-filter having an input and an output; and a third membrane filter having an input and a permeate output and a reject output, with the input of the third pre-filter connected to the reject output of the second membrane filter and the output of the third pre-filter connected to the input of the third membrane filter, with the permeate output of the third membrane filter connected to the point of use.

31. The system according to claim 30 wherein the third membrane filter is a sea water reverse osmosis unit.

32. A system according to claim 30 wherein the first and second pre-filters are selected from the group of slow sand filters, biological filters, micro-filtration filters, and ultra-filtration filters.

33. A system for removing minerals from a water source including: first means receiving water from a source for removing sediment and dissolved organic matter from the water to produce an output; a first membrane filter having an input connected to the output of the first means and having a permeate output and a reject output; second means receiving the reject output of the first membrane filter for removing sediment, impurities and dissolved organic matter from the reject output of the first membrane filter, said second means having an output; a second membrane filter having an input, a permeate output and a reject output, with the input thereof coupled to the output of the second means; and means for supplying the permeate outputs of the first and second membrane filters to a point of use.

34. A system according to claim 33 further including means coupled with at least the reject output of the first membrane filter for softening the reject output therefrom supplied to the second means.

35. A system according to claim 34 wherein the means for softening removes calcium (Ca) and magnesium (Mg) by precipitating it from the reject output of the first membrane filter.
